(19) United States
(12) Patent Application Publication
(10) Pub. No.: US 2018/0316558 A1
(43) Pub. Date: Nov. 1, 2018

(54) FAST JOINING IN WIRELESS MESH NETWORKS WITH PREDETERMINED PHYSICAL TOPOLOGIES

(71) Applicant: Linear Technology Corporation, Milpitas, CA (US)

(72) Inventors: Alain Pierre LEVESQUE, Alameda, CA (US); Lance Robert DOHERTY, Alameda, CA (US); David Ramsay Hanson BACHER, Contra Costa, CA (US); Sergey AMUR, Contra Costa, CA (US)

(21) Appl. No.: 15/963,987

(22) Filed: Apr. 26, 2018

Related U.S. Application Data
(60) Provisional application No. 62/492,636, filed on May 1, 2017.

(51) Int. Cl. H04L 12/24; H04W 40/02; H04W 76/10; H04L 12/751

(52) U.S. Cl. CPC H04L 41/0823; H04W 40/02; H04W 84/18; H04L 45/02; H04L 41/0806; H04W 76/10

(57) ABSTRACT

In a wireless mesh network having a known or predetermined physical topology, a network node or access point (AP) may promptly begin operation on the network in response to receiving a network advertisement. In particular, the node or AP can store a network communication schedule and adjust the network communication schedule based on parameter value(s) received in the network advertisement received from the network manager. As a result, the node or AP can begin operating in accordance with a network's communication schedule promptly after receiving the network advertisement by transmitting packets using pairs of communication channels and timeslots assigned thereto in the adjusted communication schedule. The network communication schedule stored by the node or AP can take the form of an algorithm that takes the parameter value(s) received in the network advertisement as input(s) and, when executed by the node or AP, outputs the appropriate adjusted network communication schedule.

### CROSS-REFERENCE TO RELATED APPLICATION

This application claims the benefit of U.S. Provisional Application No. 62/492,636, filed May 1, 2017, the disclosure of which is incorporated by reference herein in its entirety.

### TECHNICAL FIELD

The present subject matter relates to techniques and equipment for enabling wireless network nodes to efficiently joint a mesh wireless network having a predetermined physical topology.

### BACKGROUND

A wireless mesh network is a network in which wireless network nodes are configured for communication with each other across a mesh of wireless links. A network manager communicates with the wireless network nodes through its associated access point, and provides an interface between the wireless mesh network and elements outside of the mesh network (e.g., an external network, external applications, etc.).

The network manager is also configured to manage operation of the network, including adding or joining wireless network nodes to the network prior to the nodes communicating across the network. The joining of a network node typically requires exchange of a series of handshake packets between the manager and each joining wireless network node, including the transmission of a network communication schedule from the manager to the joining node. As such, the establishment of the wireless mesh network can be a time consuming process.

### SUMMARY

The teachings herein alleviate the above noted problems by enabling wireless network nodes to efficiently joint a mesh wireless network having a predetermined physical topology.

In a wireless mesh network having a known or predetermined physical topology, a network node or access point (AP) may promptly begin operation on the network in response to receiving a network advertisement. In particular, the node or AP can store a network communication schedule and adjust the network communication schedule based on parameter value(s) received in the network advertisement received from the network manager. As a result, the node or AP can begin operating in accordance with a network's communication schedule promptly after receiving the network advertisement by transmitting packets using pairs of communication channels and timeslots assigned thereto in the adjusted communication schedule. The network communication schedule stored by the node or AP can take the form of an algorithm that takes the parameter value(s) received in the network advertisement as input(s) and, when executed by the node or AP, outputs the appropriate adjusted network communication schedule.

In one illustrative embodiment, a method for enabling fast joining in a wireless mesh network may include receiving, in a wireless network node, a packet transmitted by a manager of the wireless mesh network. The packet includes a parameter value transmitted by the manager of the wireless mesh network. An adjusted communication schedule for the wireless mesh network is determined in the wireless network node based on the parameter value received in the packet and a predetermined communication schedule stored by the wireless network node. The adjusted communication schedule associates each respective node of a plurality of wireless network nodes with one or more communication channel-timeslot pairs, each communication channel-timeslot pair indicating a communication channel of a plurality of communication channels and a timeslot of a plurality of timeslots to be used by the respective node to transmit a packet on the wireless mesh network. A packet is transmitted from the wireless network node on a communication channel and during a timeslot associated with the wireless network node in the adjusted communication schedule.

In another illustrative embodiment, a wireless network node configured for fast joining to a wireless mesh network may include a wireless transceiver, a processor, and a non-transitory memory. The wireless transceiver is configured for wireless communication with wireless network nodes and access points of the wireless mesh network. The processor is communicatively connected to the wireless transceiver. The non-transitory memory device stores program instructions which, when executed by the processor, cause the wireless network node to receive via the wireless transceiver a packet transmitted by a manager of the wireless mesh network, the packet including a parameter value transmitted by the manager of the wireless mesh network. The instructions further cause the wireless network node to determine an adjusted communication schedule for the wireless mesh network based on the parameter value received in the packet and a predetermined communication schedule stored in the non-transitory memory of the wireless network node. The adjusted communication schedule associates each respective node of a plurality of wireless network nodes with one or more communication channel-timeslot pairs, each communication channel-timeslot pair indicating a communication channel of a plurality of communication channels and a timeslot of a plurality of timeslots to be used by the respective node to transmit a packet on the wireless mesh network. The instructions further cause the wireless network node to transmit via the wireless transceiver a packet on a communication channel and during a timeslot associated with the wireless network node in the adjusted communication schedule.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A is a high-level functional block diagram of a wireless mesh network system providing fast network joining capabilities.

FIG. 1B is a high-level functional block diagram of a wireless mesh network having a known physical topology.

FIG. 2A is a schematic diagram showing an illustrative communication schedule for a wireless mesh network such as those shown in FIG. 1A or 1B, and FIG. 2B is a detailed view of a portion of the illustrative communication schedule of FIG. 2A.

FIG. 3 is a flow chart showing an illustrative method for fast joining by a wireless node in a wireless mesh network such as that shown in FIG. 1.

FIG. 4 is a flow chart showing an illustrative method for determining identity of a fast-joining wireless node in a wireless mesh network such as that shown in FIG. 1.

FIG. 5 is a flow chart showing an illustrative method for fast joining by a network manager in a wireless mesh network such as that shown in FIG. 1.

FIG. 6 is a high-level functional block diagram of an illustrative wireless network node that may be used in the wireless mesh networks of FIGS. 1A and/or 1B, and/or in the methods of FIGS. 3, 4, and/or 5.

FIG. 7 is a high-level functional block diagram of an illustrative access point (AP) that may be used in the wireless mesh networks of FIGS. 1A and/or 1B, and/or in the methods of FIGS. 3, 4, and/or 5.

FIG. 8 is a high-level functional block diagram of an illustrative network manager that may be used in the wireless mesh networks of FIGS. 1A and/or 1B, and/or in the methods of FIGS. 3, 4, and/or 5.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various methods and systems disclosed herein improve efficiency in establishing a wireless mesh network by enabling wireless network nodes to determine or adjust a network communication schedule based on a parameter received from the network manager. For example, each node may determine the communication schedule based only on parameter value(s) received in a network advertisement and predetermined communication schedule information stored in the node. As a result, nodes of the wireless mesh network can begin operation promptly (e.g., in under 10 seconds) after receiving the network advertisement. Moreover, neither the nodes nor the network manager are required to engage in time-consuming network discovery or multi-packet handshakes, thereby providing a streamlined network joining and formation process that uses minimal network bandwidth.

In operation, a wireless network node can listen for a network advertisement upon start-up. A network advertisement is a packet broadcast by a network manager either directly or through one or more wireless network nodes joined to the mesh network, and that includes a network identifier (e.g., network ID) and one or more parameter value(s) used by wireless network nodes to join the mesh network. The parameter value(s) can include parameter value(s) indicative of a mesh network characteristic (e.g., mesh network size, such as a number of nodes, mesh network topology, or the like) or the like. In response to receiving the network advertisement, the wireless network node determines or adjusts a network communication schedule for the mesh network based on the received parameter value(s) received in the network advertisement and a predetermined communication schedule stored by the wireless network node. For example, the wireless network node may compute a network communication schedule that associates each respective node of the network with one or more communication channel-timeslot pairs, each communication channel-timeslot pair indicating a communication channel and a timeslot assigned for use by the respective node to transmit a packet on the wireless mesh network. The network communication schedule can be determined by executing an algorithm stored by the wireless network node and that takes as input the received parameter value(s). The wireless network node can then begin operation based on the communication schedule, for example by transmitting a network joining or other message during a communication channel-timeslot pair identified in the determined network communication schedule as being assigned to the wireless network node.

In this way, the network manager and each of the wireless network nodes in the network can promptly begin operation based on a same network communication schedule deterministically determined in each wireless network node based on the communicated parameter value(s). For example, the network manager and wireless network nodes can begin operation based on the same network communication schedule even before network joining messages are received by the network manager from each of the nodes.

Each node determines the network communication schedule based on parameter value(s) received from the network manager including one or more of (i) a random number; (ii) a network characteristic such as a number of nodes expected in the network; (iii) a scheduling characteristic such as an identification of a scheduling algorithm for the network; (iv) a timing characteristic such as a current time-slot number; and/or (v) a communication channel characteristic such as a communication channel blacklist listing communication channels not used by the network.

In cases in which the parameter value(s) include the random number, the network communication schedule is randomly selected. However, since all wireless network nodes receive the same random number as a parameter value, all wireless network nodes determine the same/common communication schedule and can thus communicate with each other in accordance with the same/common schedule that is randomly selected.

When a wireless network node begins operation and determines the network communication schedule (e.g., based on the parameter value(s) received from the network manager), the wireless network node may not know to which node of the network communication schedule it corresponds. In such situations, the wireless network node selects (e.g., at random) a plurality of communication channel-timeslot pairs that are assigned to different nodes in the network communication schedule. The network node proceeds to communicate across the wireless mesh network on the selected communication channel-timeslot pairs. In turn, in response to receiving a response from the network manager that includes a corrected node identification, the node determines that it corresponds to the identified corrected node and transmits future packets across the network using communication channel/timeslot pairs assigned to the identified corrected node in the network communication schedule.

The methods for fast joining enable network nodes to begin operating on a wireless mesh network within 10 seconds or less of receiving a network advertisement for the wireless mesh network. Specifically, by enabling joining nodes to determine a communication schedule for the network based on only parameter value(s) included in the network advertisement and stored communication schedule information such as an algorithm for determining the communication schedule, the nodes can immediately begin operating in accordance with the network's communication schedule. Moreover, the nodes are joined using minimal network bandwidth, thereby reducing the network resources needed for joining nodes to the network.

The fast joining systems and methods described herein may be advantageously used in wireless mesh networks requiring operation to begin promptly after boot-up, such as wireless mesh networks used in wireless battery monitoring systems (WBMS), rail-car monitoring, and the like. In such applications, the wireless mesh network may need to begin operation promptly after start-up of a vehicle (e.g., an electric car, a locomotive, or the like).

Further features will be discussed in detail below in relation to the examples illustrated in the accompanying drawings.

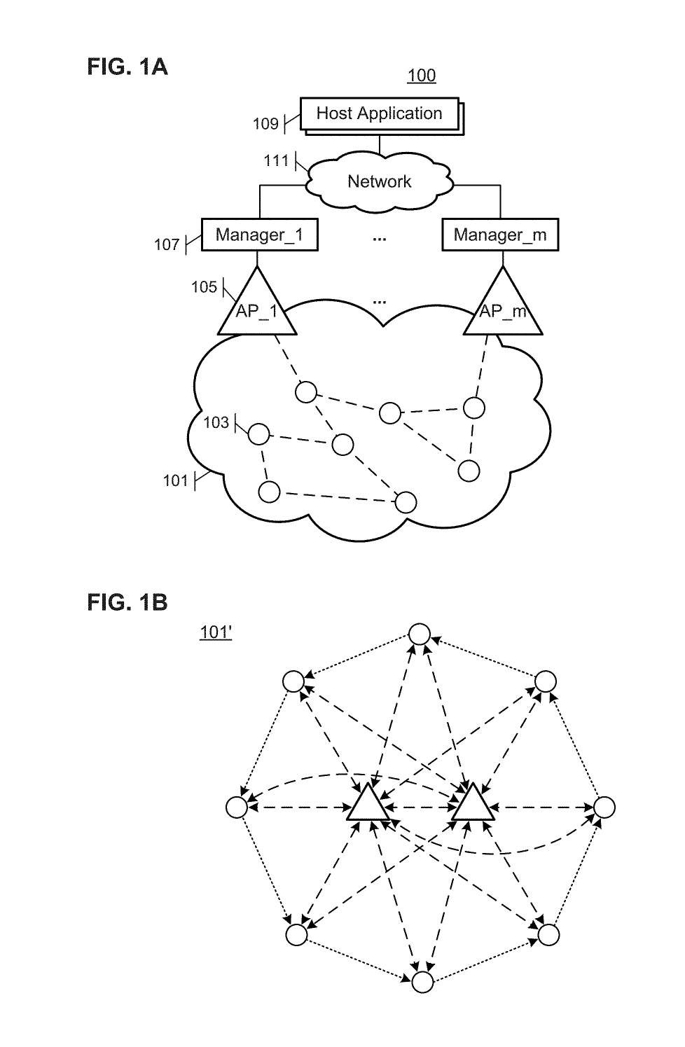

FIG. 1 illustrates an example of a wireless mesh network system 100 providing fast joining. As shown, the wireless mesh network system 100 includes a wireless mesh network 101 that includes a plurality of wireless nodes 103 (e.g., sensor nodes, or motes) and one or more access points (APs) 105 that communicate wirelessly with each other across wireless communication links (illustratively shown in dashed lines). The access point(s) 105 are communicatively connected to one or more wireless network manager(s) 107. A network manager 107 can form part of a same physical device as an associated access point 105, or can communicate with the associated AP 105 through a communication link (e.g., a wired connection) as shown in FIG. 1A.

The AP(s) 105 bridge between the wireless mesh network 101 on the one hand, and the network manager(s) 107 and elements outside of the wireless mesh network 101 on the other. For example, the AP(s) 105 and network manager(s) 107 can provide a bridge or gateway between the wireless mesh network 101 and a communication network 111 external to the wireless mesh network such as a wired communication network (e.g., the Internet) and/or a wireless network (e.g., a Wi-Fi network). The AP(s) 105 and network manager(s) 107 can also provide a bridge or gateway between the wireless mesh network 101 and host application(s) 109 (e.g., accessible through the communication network 111).

In operation, each node 103 or AP 105 of the wireless mesh network 101 can generate and send “upstream” packets to any other node 103 or AP 105 that is within its communication range, and the packets can in turn be relayed and retransmitted by the receiving node 103 or AP 105 to further nodes or APs in the network. In this way, a packet transmitted by a node 103 can propagate through the wireless mesh network 101 to any network manager 107 or external host application 109. Conversely, a node 103 can receive and process “downstream” packets that have propagated through the mesh wireless network 101 from any manager 107 or host application 109. The packets may contain data (e.g., sensor data from a sensor node, control data for an actuator node) and/or operational data for establishing or maintaining the network (e.g., a join packet used for joining a new node to the network).

In addition to providing a bridge between the wireless mesh network 101 and elements outside of the network, the wireless network manager(s) 107 manage or administer the wireless mesh network 101. A wireless network manager 107 can thus cause one or more associated AP(s) 105 to transmit or broadcast network advertisements for the wireless mesh network 101, and can in turn join to the mesh wireless network 101 nodes 103 and APs 105 from which network joining messages are received.

The wireless network manager 107 further sets a network communication schedule for the mesh wireless network 101. The network communication schedule associates each respective node joined to the network with one or more pairs of a communication channel and a timeslot. Each communication channel-timeslot pair of the communication schedule indicates a communication channel and a timeslot assigned for use by the associated node 103 to transmit a packet on the wireless mesh network 101. The associated node 103 can thus transmit a packet to one or more other node(s) of the wireless mesh network 101 that is within its communication range during each communication channel-timeslot pair that is assigned thereto. Moreover, each node 103 can receive packets from neighboring nodes whose communication ranges it is located within during communication channel-timeslot pairs assigned to the neighboring nodes. A communication channel-timeslot pair may be referred to as a communication link between nodes, and the flow of packets through the wireless mesh network 101 may be determined at least in part by the communication links included in the network's communication schedule to enable communications between pairs of neighboring nodes 103 and APs 105.

The wireless network managers 107 are also responsible for providing network security by authenticating nodes 103, APs 105, and other managers 107 joining or communicating across the network, and by enabling encryption of packets communicated across the network 101. For these purposes, the wireless network managers 107 maintain authentication data. The authentication data can include security keys (e.g., encryption and decryption keys) and counters (e.g., packet counters) used for encryption/decryption of packets and for authentication of devices in the wireless mesh network 101. Each network node 103 and/or AP 105 similarly stores and makes use of complementary authentication data including authentication keys (e.g., encryption and/or decryption keys) and packet counters. Based on the authentication data, packets can thus be encrypted by any network manager 107 prior to being sent through the wireless mesh network 101 to a network node 103 or AP 105 that can decrypt the packets, and can be decrypted by any network manager 107 upon receipt from a network node 103 or AP 105 through the wireless mesh network 101.

The physical or positional/geographical arrangement of network nodes 103 and APs 105 relative to each other in a wireless mesh network 101 is referred to as the network's physical topology. A network's topology can be random, as illustratively shown in FIG. 1A in which network nodes 103 have unsystematic positional arrangements relative to each other. Alternatively, network nodes 103 can be regularly arranged to form a network 101′ with a highly organized physical topology, one illustrative example of which is shown in FIG. 1B. The network's physical topology determines which network nodes 103 and APs 105 are within communication range of each other, and which network nodes 103 and APs 105 can thus directly communicate wirelessly with each other.

In addition to the network's physical topology, the network's communication schedule determines which nodes are provided with opportunities to communicate with each other and further determines the timing of such opportunities. In this regard, the network's communication schedule determines the network's link topology. Specifically, the network's communication schedule determines which nodes are assigned communication links or opportunities for communicating range with other nodes through the assignment of communication channel-timeslot pairs.

In situations in which a network's physical topology is unknown at the time the network in first established, and/or in situations in which a network's physical topology is variable (e.g., due to movable nodes), the network may engage in network discovery to determine which nodes 103 and APs 105 of the network are within communication range of each other. Through network discovery, the network manager can be provided with information on positions of devices (e.g., nodes 103 and APs 105) that are distributed throughout an installation, e.g., a building or a factory. The network manager 107 can then establish a communication schedule appropriate for that specific network deployment based on the result of network discovery. This network discovery takes time and consumes network resources.

In other situations, a network's physical topology may be predetermined or known ahead of establishing the communication network. For example, in a wireless battery monitoring system (WBMS), device locations may be known and fixed: for example, all devices may be located within a battery enclosure, and may be substantially within communication range of each other. In another example, in a train monitoring system, devices locations may be known and fixed along a length of the train, such that each device may be within communication range of only a few neighbor devices along the length of the train. In these cases, the network formation process can be accelerated by taking advantage of the known network physical topology to pre-program the fixed link topology and/or one or more network communication schedules appropriate for the first topology in the manager(s) 107, nodes 103, and APs 105.

A fixed link topology may refer to a predetermined arrangement of communication links between nodes 103 and APs 105 of the network 101, such that the network can automatically establish itself with the same/predetermined arrangement of communication links every time it is established. Indeed, such use cases may enable a network to form, or reform, in a matter of seconds. As detailed below, the proposed solution involves using a communication schedule for these networks that is determined by a small number of parameters and that can be calculated by any device in the network.

Advantageously, the use of communication schedules that can be efficiently calculated by any device in the network based on a small number of parameters enables nodes 103 and APs 105 to join the network in a single handshake packet per device, enables large amounts of optimally scheduled bandwidth to quickly be added at each device, and enables authentication and security to be maintained on all packets transmitted to/from joining nodes. For example, in a WBMS implementation that includes eight nodes each sending ten packets per second through two APs to two managers, a node rejoining the network in a network that is not configured for fast joining may take a full minute to rejoin the network. In contrast, by using the fast joining methods detailed herein, the node may rejoin the network in just one second.

In one illustrative example of a network having a known physical topology, the wireless mesh network 101′ of FIG. 1B may form part of a wireless battery monitoring system (WBMS). Note that the WBMS example described herein is used for illustrative purposes only, and particularities of the WBMS use case are not limiting of the scope of disclosure. In the illustrative WBMS use case, all nodes 103 and APs 105 are contained in a single battery enclosure (e.g., an enclosure for a battery in a car or other vehicle), and all eight nodes 103 and two APs 105 are thus within communication distance or range of each other. However, in order to minimize latency in network communications, the communication schedule can assign high-bandwidth links (e.g., illustratively shown in dashed lines) from each node 103 to either AP 105 of the network and assign a low-bandwidth ring of links (e.g., illustratively shown in dotted lines) for communicating packets around a ring of nodes 103 of the network 101.

In the example of FIG. 1B, every time the network rebuilds, it rebuilds with the same physical topology (e.g., the illustrative topology of FIG. 1B). Thus, the same link topology can be used, and each device can thus be assigned links to the same parent devices. Moreover, if a single node resets, it can rejoin the network with the same parents it previously had.

Given the fixed physical topology for the network, a communication schedule for the network can be deterministically created for example to provide a time-synchronized channel-hopping schedule that allows data collection to be coordinated and collision-free. The creation of the communication schedule can involve providing wireless links in the schedule at particular time(s) (i.e., at particular timeslot(s) in the slotframe) and on particular channel(s) or offset(s) in the slotframe. The deterministically created communication schedule can then be reused every time the network reforms.

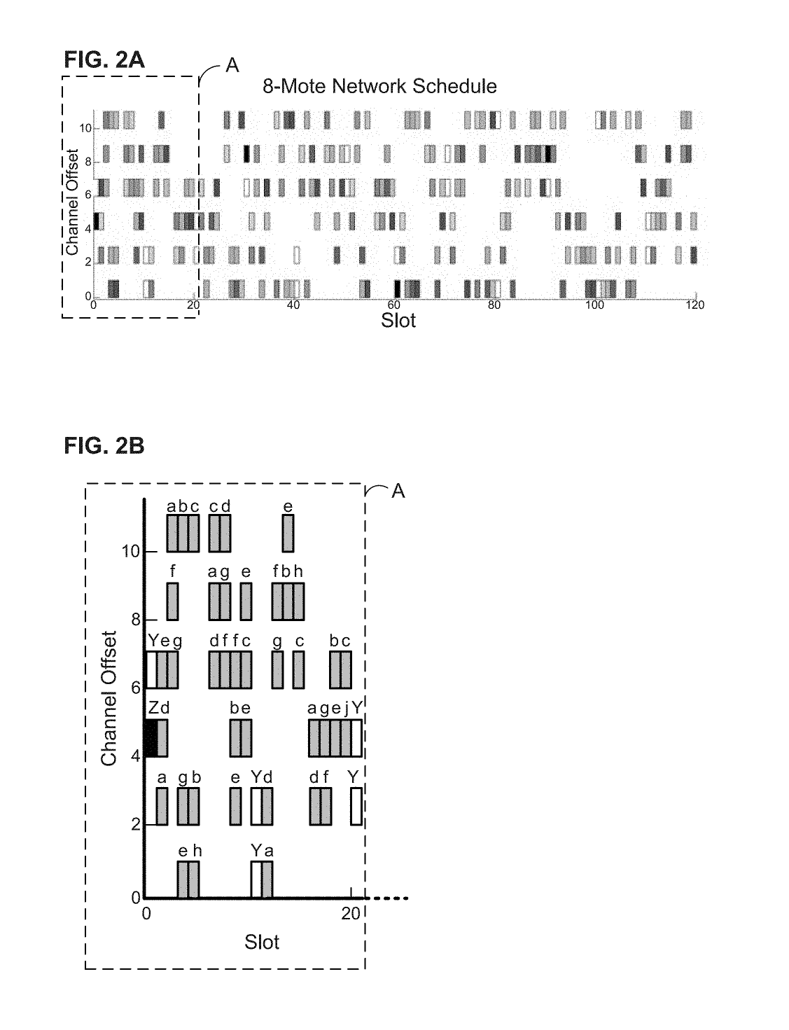

FIG. 2A is a schematic diagram showing an illustrative communication schedule for a wireless mesh network such as that shown in FIG. 1B, and FIG. 2B is a detailed view of a portion A of the communication schedule of FIG. 2A.

As shown in FIG. 2A, a communication schedule can be represented as a frame, slotframe, or array of communication channel-timeslot pairs. In the illustrated example, timeslots are plotted sequentially along the x-axis, communication channels are plotted along the y-axis, and cells in the frame or array each correspond to a communication channel-timeslot pair that can be assigned to wireless network node 103 for communication. In operation, the frame is periodically repeated, for example on a period having the length of the frame, to provide a continuous communication schedule for the wireless mesh network.

In the example shown in FIG. 2A, the frame has a length of 120 timeslots and eleven communication channel offsets providing up to 1320 cells or communication channel-timeslot pairs. The frame characterizes a communication schedule for a wireless mesh network having eight wireless nodes 103 or APs 105. As shown, cells assigned to particular transmitting nodes or APs are represented with shading associated with the particular transmitting node or AP. Additionally, in the detailed view shown in FIG. 2B, each cell assigned to particular transmitting node or AP has a letter (a-h) identifying the assigned node or AP displayed there-above. Additionally, white cells (with the identifier ‘Y’ in FIG. 2B) identify communication channel-timeslot pairs assigned for network advertisements, and black cells (with the identifier ‘Z’ in FIG. 2B) identify communication channel-timeslot pairs assigned for downstream transmission from AP(s) 105 of the network. In the illustrative communication schedule, communication channel-timeslot pairs assigned for communications between wireless nodes and APs are spaced 5 timeslots apart, and a group of communication channel-timeslot pairs assigned for communications between pairs of nodes occur at the start of the frame.

The illustrative communication schedule of FIGS. 2A and 2B can advantageously be used in the wireless mesh network 101′ of FIG. 1B, for example in WBMS applications. In the schedule, links between nodes and APs are preferably evenly spaced in time to minimize latency tails. For example, each node (a-h) can have a transmit link to a first AP (e.g., AP1) on slots 0, 10, 20, . . . , and a transmit link to a second AP (e.g., AP2) on slots 5, 15, 25, . . . . In this way, each node (a-h) is provided with an opportunity to transmit to an AP 105 every 5 slots. The links are collected in a repeating frame structure, such as the 120-slot frame schedule of FIG. 1B.

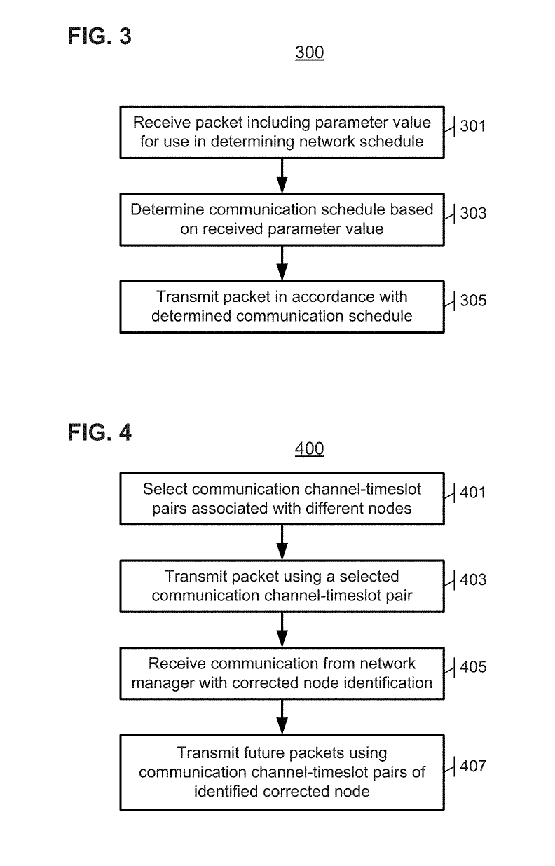

As part of enabling communication schedules to be efficiently calculated by any device in the network based on a small number of parameters, the following methods 300, 400, and 500 described in relation to FIGS. 3-5 can be used.

FIG. 3 is a flow chart showing an illustrative method 300 for fast joining of a node 103 to the wireless mesh network 101. The same method 300 can also be used for fast joining of an AP 105 to the network 101. The method includes steps for efficiently determining the communication schedule of the wireless mesh network based on parameter values received in the node 103 and predetermined information stored by the node 103.

The method 300 for fast joining of a node 103 to a wireless mesh network 101 begins in step 301 with a node 103 receiving from the network manager 107 a packet that includes one or more parameter value(s) for use in determining the network's communication schedule. The packet commonly is a network advertisement transmitted by the network manager 107 through its associated access point (AP) 105. The packet may be received through a direct wireless communication between the network manager's AP 105 and the node 103, or through an indirect wireless communication that is relayed through one or more other node(s) 103 and/or AP(s) 105 that form part of the wireless mesh network 101. The network advertisement generally includes a network identifier (Network ID) for uniquely identify the mesh wireless network 101, timing information to enable nodes seeking to join the network to synchronize to a network time reference, and the parameter value(s). If the packet received in step 301 is a network advertisement, the network node 103 can synchronize itself to the network time reference using the timing information included in the packet.

In response to receiving the packet, the network node 103 proceeds in step 303 to determine an adjusted communication schedule for the wireless mesh network 101 based on the received parameter value(s). The adjusted communication schedule is additionally determined based on a predetermined communication schedule stored by the wireless network node.

In some examples, the predetermined communication schedule can take the form of an algorithm stored in the network node 103 and that takes the received parameter value(s) as input(s). In such examples, the network node 103 executes the algorithm in step 303 and thereby computes the adjusted communication schedule for the wireless mesh network 101 as an output of the algorithm. In such examples, the algorithm outputs different adjusted communication schedules when different parameter value(s) are provided as inputs.

In some examples, the predetermined communication schedule can take the form of one or more communication schedule(s) stored in memory of the node 103. In such examples, the adjustment to the communication schedule in step 303 may involve changing one or more communication channel-timeslot pairs of the predetermined communication schedule to provide the adjusted communication schedule. For instance, only some of the communication channel-timeslot pairs of the predetermined communication schedule may be changed, while other communication channel-timeslot pairs may remain unchanged. The one or more communication channel-timeslot pairs that are changed as part of the adjustment may be deterministically identified based on the one or more parameter value(s) received in step 301, and may be changed in a deterministic manner based on the one or more parameter value(s) received in step 301. In this way, all nodes 103 or APs 105 receiving the same one or more parameter value(s) may be caused to adjust the predetermined communication schedule in the same way so as to obtain the same adjusted communication schedule in all nodes 103 and APs 105.

Once the adjusted network schedule is determined, the network node 103 proceeds in step 305 to transmit a packet on the wireless mesh network 101 in accordance with the determined communication schedule. Specifically, the wireless mesh network 101 transmits the packet on a communication channel and during a timeslot associated with the wireless network node 103 in the adjusted communication schedule.

While the foregoing description of method 300 has focused on the function of one network node 103 of the wireless mesh network 101, the method 300 is performed in all network nodes 103 of the wireless mesh network 101 and/or all network nodes 103 seeking to join the wireless mesh network 101. For example, all network nodes 103 receiving the packet of step 301 may perform the method, such as all network nodes 103 that are within communication range of the wireless mesh network 101 (e.g., all network nodes 103 that are within communication range of a node 103 or AP 105 currently joined to the wireless mesh network 101).

As method 300 is executed in various network nodes 103 (and/or APs 105) of the wireless mesh network 101, the adjusted communication schedules determined in each of the nodes 103 and APs 105 preferably are compatible with each other. Specifically, the adjusted communication schedules preferably do not cause conflicts between each other, such as by assigning to two different nodes of the wireless mesh network 101 a same communication channel-timeslot pair. To avoid such conflicts, all network nodes 103 of the wireless communication network 101 typically determine a same communication schedule based on the received parameter value(s). For this purpose, all network nodes 103 typically store the same predetermined communication schedule, such as the same algorithm for determining the communication schedule for the wireless mesh network 101. In this way, and because all network nodes 103 in the wireless mesh network 101 receive the same parameter value(s) from the network manager 107, all nodes 103 can determine and use the same adjusted network schedule.

The parameters that are used to determine the adjusted network schedule can include one or more of:
a. A random number or seed;
b. A parameter characterizing the wireless mesh network 101, such as a number (e.g., a maximum number) of nodes, APs, or devices expected in the network;
c. An index for a communication schedule or algorithm for use in the network, such as an index for selecting from among a plurality of predetermined communication schedules or algorithms stored by nodes 103 and APs 105 of the network;
d. A current time expressed in absolute slot number of the network; and/or
e. A blacklist of communication channels that are not to be included in the network communication schedule for the network.

In situations in which the parameter(s) used in determining the network schedule include a random number or seed, all nodes 103 in the network receive the same random number or seed from the network manager 107 for determining or calculating the network communication schedule. Specifically, one network manager 107 generates the random seed (e.g., from high entropy noise on the lower bits of an ADC), and that manager 107 initializes its AP 105 to transmit network advertisements containing the random seed. In this way, all nodes receive the same random seed and determine the same resultant adjusted communication schedule.

The foregoing description of steps 301-305 has focused on a use case of a network node 103 or AP 105 joining a wireless mesh network 101. The steps 301-305 may additionally or alternatively be used to make adjustments to a network's communication schedule during operation of the network, such as to cause all network nodes 103 and APs 105 that are already joined to the network 101 to begin operating according to an adjusted network communication schedule. In such situations, the network manager 107 may transmit a communication including one or more parameter value(s) in step 301, either in the form of a network advertisement, a broadcast packet transmitted to all nodes and APs, or the like. In turn, in step 303, all nodes 103 and APs 105 may determine the adjusted communication schedule, and may transition from operating according to a prior communication schedule to begin operating according to the adjusted schedule at an appropriate time (e.g., at the beginning of the following slot-frame).

The method 300 enables the wireless node 103 to determine the adjusted communication schedule for the wireless mesh network 101 (e.g., step 303) and to proceed to transmit a packet in accordance with the determined communication schedule (e.g., step 305). In some examples, however, the wireless node 103 may not know to which node of the adjusted communication schedule it corresponds, and may therefore not know which communication channel-timeslot pairs of the communication schedule are assigned thereto. In such situations, the wireless node 103 may proceed with the method 400 of FIG. 4.

FIG. 4 is a flow chart showing an illustrative method 400 for enabling a network node 103 or AP 105 to determine to which node/AP of a communication schedule it corresponds. The method 400 may be performed by a node 103 having determined an adjusted communication schedule for a wireless mesh network 101 (e.g., a node 103 having completed step 303 of method 300).

The method 400 begins in step 401 with the node 103 selecting a plurality of communication channel-timeslot pairs associated with multiple different wireless network nodes in the adjusted communication schedule. For example, the communication channel-timeslot pairs may be selected at random, such as to include communication channel-timeslot pairs assigned to a random selection of different nodes from among all nodes in the communication schedule.

The plurality of communication channel-timeslot pairs are selected to include pairs assigned to multiple different nodes such that packets transmitted by the node 103 on the selected pairs do not persistently collide or interfere with transmissions from a same other node 103 already having joined the network. Moreover, the plurality of communication channel-timeslot pairs can advantageously be selected at random such that different joining nodes select different random mixes of communication channel-timeslot pairs to thereby reduce the likelihood of persistent collisions or interference between transmissions from two joining nodes in the network 101.

Once the selection is made, the node 103 transmits packets using the selected communication channel-timeslot pairs in step 403. For example, the node may transmit a single join packet to a network manager 107 of the wireless mesh network 101 during one of the selected communication channel-timeslot pairs, and may continue to retransmit the join packet during subsequent ones of the selected communication channel-timeslot pairs until a response is received from a network manager 107.

In step 405, the node 103 receives a communication from the network manager 107 that includes a unique identifier for the node. The communication may be received in response to the join packet(s) transmitted in step 403, and may take the form of a single packet transmitted by the manager 107 that includes the correct node identification (e.g., an identifier Node ID) for the node 103. The communication may also include security keys, such as encryption and/or decryption keys, for the node 103 for use in encrypting and/or decrypting packets transmitted on or received from the wireless mesh network 101. The security keys may also include security counter values for the node 103.

Once the node 103 is apprised of its unique identifier, the node 103 can transmit all future packets using communication channel-timeslot pairs associated in the network communication schedule with the node's unique identifier (step 407 and, potentially, step 305). Thus in accordance with the method 400, even in cases in which a node 103 does not know to which node of a communication schedule it corresponds, the node 103 can determine its correct node identity (e.g., Node ID) using as little as a single packet transmitted to a manager 107 (e.g., in step 403) and a single packet received from the manager 107 (e.g., in step 405).

While the method 400 has focused on situations in which a node 103 does not know to which node of a communication schedule it corresponds, the node 103 may alternatively store its identity in non-transitory memory. In such situations, the node 103 may immediately begin transmitting packets during communication channel-timeslot pairs assigned thereto following completion of step 303. In a further example, a node 103 that does not know to which node of the communication schedule it corresponds may transmit the single join packet of step 403 (e.g., the network join packet) to the network manager 107 using a communication channel-timeslot pair that is assigned for communication of join requests packets in the network communication schedule. In such an example, processing can then proceed to steps 405 and 407 as described above.

While the methods 300 and 400 have described methods used in fast joining of a network node 103 to a wireless mesh network 101, the methods can be identically applied to an access point (AP) 105 fast joining the wireless mesh network 101. Hence, reference to node(s) 103 in the above description of methods 300 and 400 should be understood as applying to AP(s) 105. Furthermore, references to network device(s) should be understood as referring to network node(s) 103 and/or AP(s) 105.

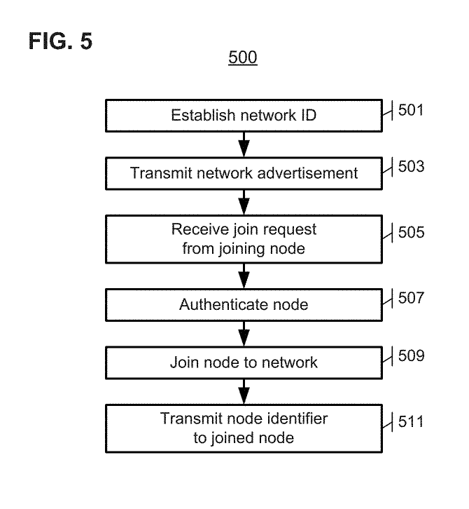

The foregoing methods have described operations performed in node(s) 103 and AP(s) 105 of the wireless mesh network 101. In conjunction with these methods, the following method 500 of FIG. 5 may be performed by the network manager(s) 107 of the wireless mesh network 101.

FIG. 5 is a flow chart showing an illustrative method 500 performed in a network manager 107 for enabling network node(s) 103 or AP(s) 105 to engage in fast joining to a wireless mesh network 101. The method 500 includes steps for joining a node 103 or AP 105 to the wireless mesh network 101 and triggering the fast joining of the node 103 or AP 105.

The method 500 begins in step 501 with a network manager 107 establishing a unique identifier (e.g., Network ID) for the wireless mesh network 101. The manager 107 further establishes a communication schedule for the network, such as a communication schedule assigning communication channel-timeslot pairs to different network nodes. The communication channels may correspond to frequency bands assigned for communication in the network 101. The communication schedule will generally include at least one network joining time interval corresponding to a combination of a timeslot and communication channel during which network joining messages can be transmitted by nodes seeking to join the network.

As part of determining the communication schedule for the network, the network manager 107 may determine whether the established wireless mesh network 101 has a known or predetermined physical topology, or whether the established wireless mesh network 101 is to be formed with network nodes 103 and APs having unknown positional relationships to each other. If the network 101 is to be established based on a known or predetermined physical topology, the network manager 107 may further determine a link topology for the network, and determine an appropriate communication schedule for the link topology. The appropriate communication schedule can in particular be determined from selection of one or more parameter values from among:
a. A parameter characterizing the wireless mesh network 101, such as a number (e.g., a maximum number) of nodes, APs, or devices expected in the network;
b. An index for a communication schedule or algorithm for use in the network, such as an index for selecting from among a plurality of predetermined communication schedules or algorithms stored by nodes 103 and APs 105 of the network; and/or
c. A current time expressed in absolute slot number of the network.

The network manager 107 may determine further parameter values such as a random number or seed for use in generating the network communication schedule, and/or determine a blacklist of communication channels that are not to be included in the network communication schedule for the network (e.g., a list of channels known to have low reliability).

Once the parameter value(s) to be used in generating the network communication schedule are selected, the network manager 107 determines an adjusted communication schedule for the wireless mesh network 101 based on the determined parameter value(s). The adjusted communication schedule is additionally determined based on the predetermined communication schedule stored by the wireless network node, such as an algorithm stored in the network manager 107 and that takes the received parameter value(s) as input(s).

In step 503, the network manager 107 transmits a network advertisement through its associated access point (AP) 105. The network advertisement generally includes the network identifier (e.g., Network ID), timing information to enable nodes seeking to join the network to synchronize to a network time reference, and the one or more parameter value(s) used by wireless network nodes to join the mesh network. The network advertisement is transmitted wirelessly through the network manager's AP 105 to any nodes 103 that are within communication range of the AP 105, and is relayed through the wireless mesh network 101 by any nodes 103 already joined to the network 101.

The transmission of the network advertisement in step 503 may trigger method 300, and optionally method 400, to be performed in one or more nodes 103 or APs 105 having received the advertisement. As part of performing these methods, a node 103 or AP may transmit a network join request packet (e.g., step 403) which may be directly wirelessly received by the AP 105 of the manager 107 or may propagate through the wireless mesh network 101 to the manager 107.

The network join request transmitted by the network node 103 propagates through the wireless mesh network 101 until it reaches the AP 105 and network manager 107. The network manager 107 receives the network join request through its AP 105 in step 505 and proceeds to authenticate the node in step 507.

As part of the authentication of the network node 103 seeking to join the wireless network, the network manager 107 may retrieve from the received join request an identifier for the node 103 and determine whether the identified node is authorized for communication on the wireless mesh network 101. If the authentication of the joining network node 103 is successful, operation proceeds to step 509.

In step 509, the network manager 107 joins the node 103 to the network. Part of the joining process can include identifying to which node the joining node 103 corresponds from among the nodes included in the network communication schedule, such as by determining a node identifier (e.g., Node ID) for the joining node 103. Optionally in step 509, the network manager 107 generates and stores authentication data for the joined node 103, such as a set of encryption/decryption session keys (e.g., unicast session key for the joined node 103) to be used for all subsequent communication with the joined node 103. The network manager 107 can further initiate (or reset) counters used for authentication and security purposes in subsequent communications with the joined node 103, such as counters used to prevent replay attacks.

Once the node 103 has been joined to the network, the network manager 107 proceeds in step 511 to transmit a join response packet to the joined network node 103. The join response packet is transmitted to the joined network node 103 through the AP 105 and the wireless mesh network 101. The join response packet includes the network identifier (e.g., network ID) for the joined node 103. The join response packet can additionally include authentication data for the joined network node 103, including the encryption and/or decryption session keys.

In further operation of the wireless mesh network 101, network nodes 103 and APs of the wireless mesh network 101 exchange packets in accordance with the communication schedule determined in each of the network nodes 103 and APs 105 based on the parameter values communication by the network manager 107. Specifically, when a node 103 or AP 105 has a packet to transmit, the node 103 or AP 105 may wait until the next timeslot of the communication schedule during which the node 103 or AP 105 is assigned a communication link. When the assigned timeslot is reached, the node 103 or AP 105 can then transmit the packet on the communication channel associated with the timeslot in the network communication schedule.

In the illustrative WBMS example discussed herein, one parameter used to determine network's communication schedule may be a random number or seed. In one example, the random number or seed used as a parameter value can fix timeslots used by the various nodes 103 so as to get randomness in the schedule by varying each link's channel offset. In the frames of FIGS. 2A and 2B, for example, the illustrative communication schedule uses only even channel offsets and has a maximum of three used cells per timeslot. The communication schedule calculation algorithm can pick a random even channel offset for the first used channel in each timeslot, then add two to get the second used channel and another two to get the third used channel. All addition is modular (e.g., modulo the total number of channels, e.g. modulo 11).

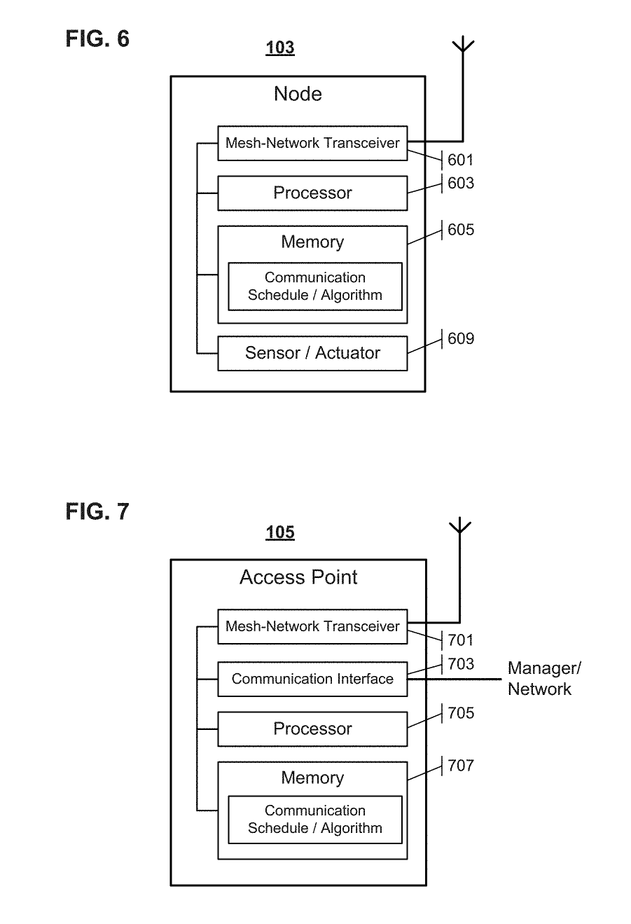

The foregoing description has described functions performed by the various nodes 103. APs 105, and managers 107 of the wireless mesh network 101. FIGS. 6, 7, and 8, which are described in detail below, show illustrative embodiments of a node 103, an AP 105, and a network manager 107 that may be used to implement and perform the above-described functionalities.

FIG. 6 shows a high-level functional block diagram of an illustrative node 103 used in the network system 100 of FIG. 1. The node 103 includes a processor 603 (e.g., a microprocessor) and a memory 605 that provide processing capabilities. The memory 605 stores application programs and instructions for controlling operation of the node 103, and the processor 603 is configured to execute the application programs and instructions stored in the memory 605. In particular, through execution of the application programs stored in memory 605, the processor 603 may cause the node 103 to perform functions such as those described in this disclosure including functions to determine a communication schedule based on parameter value(s) received from a network manager.

Additionally, the node 103 can include a sensor 609 producing sensing or measurement data that is provided to the processor 603 and/or stored in memory 605. The node 103 can additionally or alternatively include an actuator (e.g., a motor, valve, or the like) or other operational output (e.g., a display) that is controlled by the processor 603. The node 103 further includes a transceiver 601 that enables communication across the network (e.g., a wireless mesh-network) with other nodes 103 or APs 105. As shown in FIG. 6, the transceiver 601 is a wireless transceiver 601 connected to an antenna and configured for wireless communication; in other embodiments, the transceiver 601 may be a wired transceiver. The various components of the node 103 are communicatively connected to each other (e.g., via a bus or other communication lines).

As described in detail above, the node 103 stores in memory 605 a predetermined communication schedule that can take the form of an algorithm for determining communication schedules based on received parameter value(s). The processor 603 of the node 103 can perform processing based on the predetermined communication schedule, such as by executing the stored algorithm and providing the received parameter value(s) as inputs to the algorithm, to determine a communication schedule. In turn, the processor 603 can cause the node to communicate across the wireless mesh network 101 in accordance with the determined communication schedule. Further functions relating to the node operation are described in detail above, for example in relation to methods 300, 400, and 500.

FIG. 7 shows a high-level functional block diagram of an illustrative AP 105 used in the network system 100 of FIG. 1. The AP 105 includes components substantially similar to those of the node 103, including a mesh-network transceiver 701, a processor 705 (e.g., a microprocessor), and a memory 707. Such components of the AP 105 are substantially similar to corresponding components of the node 103, and reference can be made to the description of the node 103 for detailed information on the components and their functions. For example, the memory 707 may store application programs which, when executed by processor 705, cause the AP 105 to perform functions such as those described in this disclosure including functions to determine a communication schedule based on parameter value(s) received from a network manager. The AP 105 optionally includes a sensor, actuator, or other operational output that is controlled by the processor 705, similarly to the node 103.

As described in detail above, the AP 105 stores in memory 707 a predetermined communication schedule that can take the form of an algorithm for determining communication schedules based on received parameter value(s). The processor 705 of the AP 105 can perform processing based on the predetermined communication schedule, such as by executing the stored algorithm and providing the parameter value(s) received from the network manager 107 as inputs to the algorithm, to determine a communication schedule. In turn, the processor 705 can cause the AP to communicate across the wireless mesh network 101 in accordance with the determined communication schedule. Further functions relating to the AP operation are described in detail above, for example in relation to methods 300, 400, and 500.

Additionally, the AP 105 can include dual communication interfaces: a first communication interface (e.g., a mesh-network transceiver 701) configured for communication with nodes 103 of the network 101, and a second communication interface 703 (e.g., a WAN transceiver) configured for communication outside of the mesh-network such as communications with the network manager 107 or with application(s) 109 and/or communication network 111 (e.g., via the network manager 107). In our example, the mesh-network transceiver 701 may be a wireless transceiver, while the second communication interface 703 may be a transceiver configured for wired communications (e.g., a transceiver compatible with Ethernet standards) directly with the network manager 107 or indirectly via one or more network(s). While two communication interfaces are shown in FIG. 7, some embodiments may include a single transceiver performing both communications functions, while in other embodiments communications with the network manager 107 may be via a direct wired link.

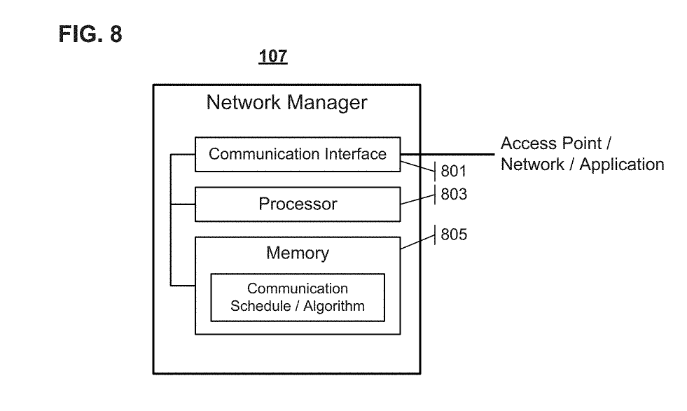

FIG. 8 shows a high-level functional block diagram of an illustrative network manager 107 used in the network system 100 of FIG. 1. The network manager 107 controls operations of the mesh network, and serves as an interface between the network and the outside (e.g., as an interface between the wireless mesh network 101 and an external network 111, external application(s) 109, or the like). Specifically, all communications between the mesh network and external applications 109 or external network 111 may flow through a network manager 107, or otherwise be controlled by a network manager 107.

The network manager 107 is shown in FIG. 1 as being a separate entity from the AP 105, and as being physically separate from any AP 105. In such embodiments, the network manager 107 and AP(s) 105 are separate entities and may be communicatively connected via a communication cable (as shown), one or more wired or wireless network(s), and/or one or more wireless communication links. In other embodiments, the network manager 107 may be co-located with one AP 105, for example within a same device casing. In such embodiments, the network manager 107 and AP 105 may have distinct processors, may be mounted on distinct circuit boards, and may be communicatively connected by wire traces between the circuit boards. In further embodiments, the network manager 107 may execute on a same processor as an AP 105.

The network manager 107 includes a processor 803 (e.g., a microprocessor) and a memory 805 that provide processing capabilities. The memory 805 stores application programs and instructions for controlling operation of the network manager 107, and the processor 803 is configured to execute the application programs and instructions stored in the memory 805 and control operation of the manager 107. In particular, through execution of the application programs stored in memory 805, the processor 803 may cause the network manager 107 to perform functions such as those described in this disclosure.

As described in detail above, the network manager 107 maintains in memory 805 a predetermined communication schedule that can take the form of an algorithm for determining communication schedules based on received parameter value(s). The processor 803 of the network manager 107 can perform processing to determine appropriate parameters and corresponding parameter value(s) to be used in establishing a network communication schedule. The processor 803 may further perform processing based on a predetermined communication schedule stored in memory, such as by executing the stored algorithm and providing the determined parameter value(s) as inputs to the algorithm, to determine a communication schedule. In turn, the processor 803 can cause the AP 105 associated with the manager 107 to transmit a network advertisement across the wireless mesh network 101 including the determined parameter value(s). Further functions relating to the network manager operation are described in detail above, for example in relation to method 500 as well as methods 300 and 400.

Additionally, the network manager 107 includes a communication interface 801 such as a transceiver for communication via network(s) 111. While a single communication interface 801 is shown in FIG. 8, the network manager 107 can include multiple transceivers, for example in situations in which the network manager 107 communicates using different communications standards or protocols, or using different networks or communications links, with its associated AP 105, the application(s) 109, and/or the networks 111 or servers. For instance, a dedicated communication interface (e.g., a dedicated port) can be included for communication with the AP 105 of the mesh network 101. As shown in FIG. 8, the communication interface 801 may be a wired transceiver connected to network 111; in other embodiments, the network manager 107 includes one or more wireless transceivers connected to antennas and configured for wireless communication.

The various components of the network manager 107 are communicatively connected to each other (e.g., via a bus or other communication lines), and are electrically connected to a power source to receive operating power.

The network manager 107 provides oversight of the mesh network, and can control operation of the network. For example, the network manager 107 joins nodes to the network, sets network timing and/or sets the network communication schedule, and performs other network administration based on program instructions stored in memory 805 and executed on processor 803. In addition, as part of joining nodes and APs to the network, the network manager 107 can receive identification information from nodes 103 and AP(s) 105 and can authenticate the nodes and AP(s) based on the identification information. In some examples, the authentication is performed in concert with an authentication server by transmitting identification information to the authentication server and obtaining an authentication confirmation or an authentication denial from the server. In other examples, the authentication is performed locally by the network manager 107 based on the identification information. Furthermore, during operation of the network, the network manager can encrypting packets prior to transmitting them across the wireless mesh network 101, and/or decrypting packets received through the wireless mesh network 101 prior to relaying them to host applications 109 and/or external networks 111.

In accordance with the foregoing description, when a wireless network device (e.g., a new node 103 or AP 105) boots (or reboots), the device listens for a network advertisement. Upon hearing a network advertisement include one or more parameter value(s) used in fixed topology implementations, the device can immediately calculate a communication schedule instead of waiting for a set of handshake packets to establish the network topology and communication schedule. If the joining device knows its Node ID, it can immediately start network operation (e.g., transmitting packets) using the proper network communication schedule. Otherwise, the joining device may wait until receipt of a network join response including the Node ID to begin transmitting packets during communication channel-timeslot pairs assigned to the Node II) in the network communication schedule.

In the illustrative WBMS use case discussed herein, all nodes 103 are connected to both APs 105 in FIG. 1B and all nodes 103 have the same bandwidth requirements. In a more general case, a link topology may be established to provide different connectivity and to provide different nodes 103 with different numbers of transmit links to meet their data publishing requirements. Provided this information is known a priori, an appropriate network communication schedule similar to the WBMS schedule can be created and stored into all nodes 103 and APs 105 in the network. For example, instead of a first node ‘a’ transmitting directly to both access points 105 of FIG. 1B, AP1 and AP2, the first node may transmit instead to a second node with five links and to a third node ‘c’ with five links, and both the second and third nodes may subsequently transmit to both APs with twenty links. In any of these cases, the connectivity of the nodes 103 and APs 105 network is preferably well known in advance. Indeed, in such an example, if the first node is out-of-range of the second and third nodes, it may not be able to join or communicate across the wireless mesh network 101′.

If devices (e.g., nodes 103 and APs 105) are to support several connectivity patterns that are possible but not known until deployment, one algorithm for each pattern can be pre-programmed for each pattern on all devices. At run-time, the manager 107 can be told which algorithm index to advertise. Similarly, different algorithm indices can be used to assign different amounts of homogeneous bandwidth to all nodes in the network.

In one WBMS example, a random seed can be used to randomize the channel offsets but not the timeslots. In general, an algorithm could use a random seed to randomize the timeslot assignment in addition to or instead of the channel offsets.

While the foregoing has focused on a particular WBMS example for illustrative purposes, the concepts described herein can more generally be used in further examples to switch between regular device operation and fast-joining/fixed-topology operation based on the network advertisement type transmitted by the network manager and received by joining devices. Additionally or alternatively, an algorithm for creating a new schedule can be transmitted to devices in a network through an over-the-air provisioning (OTAP) process. The devices may receive and store the new scheduling algorithm received through the OTAP process for use in future fast-joining operations. Using such a process, an entire network can be switched to a different deterministic schedule at a time in the future, e.g. to overcome measured interference. For multi-hop networks, nodes can assign algorithmic schedules to children nodes that join through them instead of going all the way up to the network manager.

For smaller networks, the network advertisement may contain a mapping of the each node's MAC address to a Node ID so it can immediately know its schedule, where the MAC address is eight bytes per node though so this may require use of compression in order to implement on devices with limited memory.

The systems and methods detailed above enable fast joining of nodes in networks with well-known connectivity. The approaches leverage the network advertisement structure to randomize network communication schedules within a set of deterministic schedules. Additionally, joining of nodes to the network can be performed using a single downstream (manager-to-node) packet, such that joining can be performed without use of downstream transport sessions which were previously used to provide dedicated conduits for joining handshake packets between a particular manager and the node. Since no downstream transport sessions are needed, multiple independent managers can be used for joining to therefore provide redundancy and reduce bandwidth limitations.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method for enabling fast joining in a wireless mesh network, the method comprising:
receiving, in a wireless network node, a packet transmitted by a manager of the wireless mesh network, the packet including a parameter value transmitted by the manager of the wireless mesh network;
determining, in the wireless network node, an adjusted communication schedule for the wireless mesh network based on the parameter value received in the packet and a predetermined communication schedule stored by the wireless network node,
wherein the adjusted communication schedule associates each respective node of a plurality of wireless network nodes with one or more communication channel-timeslot pairs, each communication channel-timeslot pair indicating a communication channel of a plurality of communication channels and a timeslot of a plurality of timeslots to be used by the respective node to transmit a packet on the wireless mesh network; and
transmitting, from the wireless network node, a packet on a communication channel and during a timeslot associated with the wireless network node in the adjusted communication schedule.

2. The method of claim 1, wherein the predetermined communication schedule stored by the wireless network node comprises an algorithm, and
the determining the adjusted communication schedule comprises executing the algorithm to determine the adjusted communication schedule for the wireless mesh network based on the parameter value received from the manager, such that different adjusted communication schedules are determined for the wireless mesh network for different parameter values.

3. The method of claim 2, wherein the received packet transmitted by the manager is a network joining message that includes the parameter value and is relayed to the wireless network node through one or more other wireless network nodes of the wireless mesh network, and
the algorithm is executed in response to receiving the network joining message.

4. The method of claim 3, wherein the parameter value included in the network joining message is indicative of a maximum number of wireless network nodes to be included in the wireless mesh network, and
the algorithm determines the adjusted communication schedule for the wireless mesh network based on the maximum number of wireless network nodes indicated in the network joining message.

5. The method of claim 2, wherein the algorithm determines the adjusted communication schedule for each of the plurality of wireless network nodes of the wireless mesh network, and
wherein the method further comprises:
receiving, in the wireless network node from the manager of the wireless mesh network, identification of a particular wireless network node of the plurality of wireless network nodes of the wireless mesh network; and
transmitting packets, by the wireless network node across the wireless mesh network, using only communication channel-timeslot pairs associated with the identified particular wireless network node in the adjusted communication schedule.

6. The method of claim 5, further comprising:
prior to receiving the identification of the particular wireless network node in the wireless network node, communicating, by the wireless network node across the wireless mesh network, using a plurality of communication channel-timeslot pairs associated with different wireless network nodes in the adjusted communication schedule.

7. The method of claim 1, wherein the transmitting of the packet comprises transmitting a network joining request from the wireless network node to a manager of the wireless mesh network during a first timeslot of a first communication channel-timeslot pair of the plurality of communication channel-timeslot pairs, the first timeslot being associated with requests for joining the wireless mesh network.

8. The method of claim 1, wherein the plurality of wireless network nodes of the wireless mesh network have a predetermined physical topology including pairs of wireless network nodes that are within wireless communication range of each other, and
the adjusted communication schedule determined based on the received parameter value associates, with each communication channel-timeslot pair, a pair of wireless network nodes that are within wireless communication range of each other according to the predetermined physical topology of the wireless network nodes.

9. The method of claim 1, wherein each respective wireless network node of the plurality of wireless network nodes of the wireless mesh network stores a predetermined communication schedule comprising a respective algorithm, and each respective algorithm is configured to determine an adjusted communication schedule for the respective wireless network node that is compatible with respective adjusted communication schedules determined by respective algorithms of all other wireless network nodes of the wireless mesh network.

10. A wireless network node configured for fast joining to a wireless mesh network, the wireless network node comprising:
a wireless transceiver configured for wireless communication with wireless network nodes and access points of the wireless mesh network;
a processor communicatively connected to the wireless transceiver; and
a non-transitory memory device storing program instructions which, when executed by the processor, cause the wireless network node to:
receive via the wireless transceiver a packet transmitted by a manager of the wireless mesh network, the packet including a parameter value transmitted by the manager of the wireless mesh network;
determine an adjusted communication schedule for the wireless mesh network based on the parameter value received in the packet and a predetermined communication schedule stored in the non-transitory memory of the wireless network node,
wherein the adjusted communication schedule associates each respective node of a plurality of wireless network nodes with one or more communication channel-timeslot pairs, each communication channel-timeslot pair indicating a communication channel of a plurality of communication channels and a timeslot of a plurality of timeslots to be used by the respective node to transmit a packet on the wireless mesh network; and
transmit via the wireless transceiver a packet on a communication channel and during a timeslot associated with the wireless network node in the adjusted communication schedule.

11. The wireless network node of claim 10, wherein the predetermined communication schedule stored in the non-transitory memory of the wireless network node comprises an algorithm, and
the program instructions, when executed by processor to determine the adjusted communication schedule, further cause the wireless network node to:
execute the algorithm to determine the adjusted communication schedule for the wireless mesh network based on the parameter value received from the manager, such that different adjusted communication schedules are determined for the wireless mesh network for different parameter values.

12. The wireless network node of claim 11, wherein the received packet transmitted by the manager is a network joining message that includes the parameter value and is relayed to the wireless network node through one or more other wireless network nodes of the wireless mesh network, and
the program instructions cause the wireless network node to execute the algorithm in response to receiving the network joining message.

13. The wireless network node of claim 12, wherein the parameter value included in the network joining message is indicative of a maximum number of wireless network nodes to be included in the wireless mesh network, and
the program instructions cause the wireless network node to execute the algorithm to determine the adjusted communication schedule for the wireless mesh network based on the maximum number of wireless network nodes indicated in the network joining message.

14. The wireless network node of claim 11, wherein the algorithm determines the adjusted communication schedule for each of the plurality of wireless network nodes of the wireless mesh network, and
the program instructions further cause the wireless network node to:
receive, via the wireless transceiver from the manager of the wireless mesh network, identification of a particular wireless network node of the plurality of wireless network nodes of the wireless mesh network; and
transmit packets, via the wireless transceiver across the wireless mesh network, using only communication channel-timeslot pairs associated with the identified particular wireless network node in the adjusted communication schedule.

15. The wireless network node of claim 14, wherein the program instructions further cause the wireless network node to:
prior to receiving the identification of the particular wireless network node, communicate, via the wireless transceiver across the wireless mesh network, using a plurality of communication channel-timeslot pairs associated with different wireless network nodes in the adjusted communication schedule.

16. The wireless network node of claim 10, wherein the program instructions, when executed by the processor to transmit the packet, further cause the wireless network node to transmit a network joining request via the wireless transceiver to a manager of the wireless mesh network during a first timeslot of a first communication channel-timeslot pair of the plurality of communication channel-timeslot pairs, the first timeslot being associated with requests for joining the wireless mesh network.

17. The wireless network node of claim 10, wherein the plurality of wireless network nodes of the wireless mesh network have a predetermined physical topology including pairs of wireless network nodes that are within wireless communication range of each other, and
the adjusted communication schedule determined based on the received parameter value associates, with each communication channel-timeslot pair, a pair of wireless network nodes that are within wireless communication range of each other according to the predetermined physical topology of the wireless network nodes.

18. The wireless network node of claim 10, wherein each respective wireless network node of the plurality of wireless network nodes of the wireless mesh network stores a predetermined communication schedule comprising a respective algorithm, and each respective algorithm is configured to determine an adjusted communication schedule for the respective wireless network node that is compatible with respective adjusted communication schedules determined by respective algorithms of all other wireless network nodes of the wireless mesh network.
